(19) United States
(12) Patent Application Publication
(10) Pub. No.: US 2008/0286622 A1
(43) Pub. Date: Nov. 20, 2008

(54) Transient Recognition Control for Hybrid Fuel Cell Systems

(75) Inventors: Steven R. Shaw, Bozeman, MT (US); Tao Zhu, Bozeman, MT (US); Steven B. Leeb, Cambridge, MA (US)

Correspondence Address: COOLEY GODWARD KRONISH LLP;ATTN: Patent Group, Suite 1100, 777 - 6th Street, NW, WASHINGTON, DC, 20001, US

(73) Assignees: MONTANA STATE UNIVERSITY-BOZEMAN, Bozeman, MT (US); MASSACHUSETTS INSTITUTE OF TECHNOLOGY, Cambridge, MA (US)

(21) Appl. No.: 11/568,971

(22) PCT Filed: May 11, 2005
(86) PCT No.: PCT/US2005/016170

§ 371 Date: Jul. 23, 2008

Related U.S. Application Data
(60) Provisional application No. 60/569,644, filed on May 11, 2004.

(51) Int. Cl. H01M 8/04

(52) U.S. Cl. 429/23

(57) ABSTRACT

This invention is directed to a novel power control scheme that uses feedforward information about load transient behavior to manage the flow of energy between components of a hybrid fuel cell system. The methods of the invention may also be applicable to hybrid systems with critical sources other than fuel cells. Methods of the invention for controlling a power generation system comprise using a transient recognition control module to estimate the steady state information of load transients. The transient recognition control module can be based upon a cluster weighted modeling algorithm, which can be formulated recursively and provide useful feed-forward information in real time.

### CROSS REFERENCE TO RELATED APPLICATION

This application claims priority to U.S. PCT Application No. 60/569,644, filed May 11, 2004, the contents of which are incorporated herein by reference in their entirety.

### STATEMENT REGARDING FEDERALLY SPONSORED RESEARCH OR DEVELOPMENT

This invention was partially made with government support under United States Department of Energy Grant No. R02413060 through Pacific Northwest National Laboratory Grant #3917. The U.S. government has certain rights in this invention.

### INCORPORATION-BY-REFERENCE OF MATERIAL SUBMITTED ON A COMPACT DISC

Not applicable

### SEQUENCE LISTING

Not applicable

### TECHNICAL FIELD

This application relates to a hybrid fuel cell system with an improved power control scheme based on transient recognition control.

### BACKGROUND OF THE INVENTION

Fuel cells have attracted much attention as an efficient, scalable, low-pollution means of generating electrical power. A short list of potential fuel cell applications includes distributed power generation, auxiliary and primary generation in transportation systems, consumer electronics and backup generation. Load transients in many fuel cell applications involve significant peaks in power relative to the steady-state demand.

The effects of load transients can be reduced by combining fuel cells with energy storage devices such as capacitors or batteries to form a hybrid system [1], [2], [3], [4], [5], [6], [7], [8]. Hybrid fuel cell systems have been proposed for improved transient response in several scenarios. For example, Proton Exchange Membrane (PEM) fuel cells are considered in combination with lead acid batteries, Li-ion batteries, and capacitors as energy storage elements for portable military electronics and communication applications. See e.g., [1], [4], [6], [7], [8]. Hybridsystems are more efficient in working with impulse type loads, more reliable in general, and offer smaller size and weight than the PEM fuel cells working alone. A fuel cell system coupled with a superconducting magnetic energy storage system (SMES) is proposed in [5] for a distributed generation system. SMES enables the hybrid system to compensate for transients in the utility system caused by the sudden change of real and reactive power load requirements. The authors of [2] investigate the hybridization of a direct methanol fuel cell (DMFC) with an all-solid-state super-capacitor, showing that the cell power is improved by over 30% compared with that of the DMFC alone at 25° C. The authors in [9], [10], [11], [12], [13] consider combining fuel cells with batteries or super-capacitors for electric vehicle applications. Hybrid systems are preferred in electric vehicles because they provide flexibility and efficiency in operating the fuel cells [11].

Simple hybrid fuel cell systems connect the energy storage device in parallel with the fuel cell. During a transient, the portion of current delivered from the fuel cell is determined implicitly by the impedances of the fuel cell and the storage device. See e.g., [3]. Some hybrid systems control the fuel cell to output approximately constant power. In these applications, the storage device handles all of the transient energy, and the fuel cell operates like a battery charger. See e.g., [1], [4], [5], [6].

The aforementioned means of minimizing the effects of load transients are problematic, in part because they do not effectively anticipate the future behavior of the transient. There is a need for improved transient performance of a hybrid fuel cell system that can determine the future behavior of the transient. In particular, there is a need for a fuel cell, or other critical source, that can be controlled so that it does not respond to the large initial current typical of a load transient. Citation of any reference in this section of the application is not to be construed as an admission that such reference is prior art to the present application.

### SUMMARY OF THE INVENTION

The present invention relates to a method for controlling a power generation system comprising using a transient recognition control module to estimate the steady state information of load transients. The transient recognition control module can be based upon a cluster weighted modeling algorithm. The power generation system can be a hybrid fuel cell system. The cluster weighted modeling algorithm can be formulated recursively and provide useful feed-forward information in real time.

The present invention also relates to a method for controlling a power generation system comprising: a) providing a power electronics source which is electrically connected to a power generation source, an energy storage device, a transient recognition control device, and a DC bus; b) providing a current sensor that is electrically connected to a transient recognition control device; c) estimating the steady state load transient information in the transient recognition control device using a computer weighted modeling algorithm; d) adjusting the use of energy from the storage device and the power generation source based upon an input command signal from the transient recognition control system to the power electronics; and

d) regulating the voltage on the DC bus based upon a signal from the power electronics.

### BRIEF DESCRIPTION OF THE DRAWINGS

For a more complete understanding of the present invention and for further advantages thereof, reference is made to the following drawings:

FIG. 1 is a hybrid power control scheme combining fuel cells or other critical source with energy storage devices.

FIG. 2 is a theoretical comparison of conventional control and transient based control responses to a load transient.

FIG. 3 is graphical explanation of cluster-weighted modeling.

FIG. 4 is a graph of informative segments (v-sections) in a load transient.

FIG. 5 is a graph showing the convergence of the joint log-likelihood maximization.

FIG. 6 shows testing results of recursive recognition for different load transients.

FIG. 7 is a power control scheme for multi-source test system implementation.

FIG. 8 shows testing results of the hybrid fuel cell system responses to bulb transient.

FIG. 9 shows testing results of the simple fuel cell system responses to bulb transient.

FIG. 10 shows testing results of the hybrid fuel cell system responses to lathe transient.

FIG. 11. shows testing results of the simple fuel cell system responses to lathe transient.

FIG. 12 is a table showing a summary of key notation.

### DETAILED DESCRIPTION OF THE INVENTION

The present invention is directed to a novel power control scheme that uses feed-forward information about load transient behavior to manage the flow of energy between components of a hybrid fuel cell system. This control scheme may allow designers to minimize energy storage requirements, improve the system reliability, reduce internal loss, and extend the lifetime of fuel cell systems. The methods of the invention may also be applicable to hybrid systems with critical sources other than fuel cells.

The present invention relates to a more flexible system motivated by the near real-time transient recognition capabilities of the Nonintrusive Load Monitor (NILM) in [23], [14]. The NILM is capable of desegregating and recognizing individual loads from a current waveform using a library of transient signatures. The hybrid control problem of this invention differs from NILM in that the identification of the long-range transient behavior happens quickly, on the time-scale of the transient. To address the unique constraint of the hybrid system control the present invention uses a modified Cluster-Weighted Modeling (CWM) scheme. CWM, introduced in [16], [17], [18] is a novel method that can establish complex functional relationships between input patterns and associated outputs. However, like NILM and most other pattern recognition schemes, CWM nominally requires the arrival of a full pattern. The latency associated with this requirement is unacceptable in the hybrid control scenario. The present invention provides a solution to this problem in the form of a recursive modification of the cluster weighted modeling scheme. See [19]. The present invention is directed to the performance of a prototype hybrid system comprises a fuel cell and battery using commands from a simulated CWM-based transient recognition control.

This invention proposes a novel power control scheme using transient recognition control (TRC). This is developed in the context of a fuel cell system, but applies as well to similar systems with transient-sensitive sources. The following gives an overview of the recursive CWM method developed in [19]. The examples provide a few simulation results demonstrating the capabilities of recursive CWM in this application and experimental results showing the behavior of the power electronics and loads under transient recognition control. A hybrid system with transient recognition control is compared to simple connection of power electronics to a fuel cell.

### Novel Power Control Scheme for Hybridfuel Cell Systems

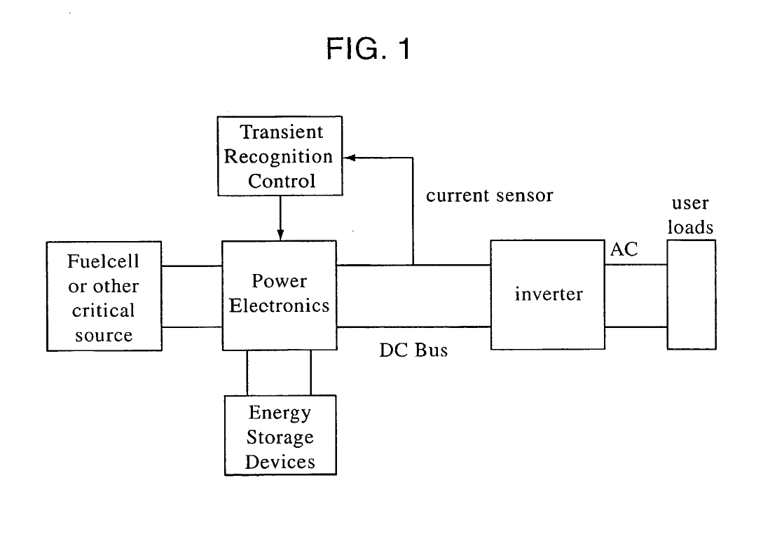

FIG. 1 shows the proposed transient-based control scheme for a hybrid system using storage elements and critical sources such as fuel cells. The current demanded for the fuel cell is determined by the recognition of the load transient. The system in FIG. 1 shows an inverter and AC load, but DC loads could also be used. The power electronics in FIG. 1 regulate the voltage on the DC bus and use the input command from the transient recognition control module to adjust the use of energy from the storage devices and the critical sources during a transient. The strategy in FIG. 1 allows critical loads to respond in the most efficient way to the long-term demands of the transient, because the transient recognition module estimates the long-term transient properties from the initial behavior. In contrast, the response of a conventional control is a relatively simple function of the initial part of the transient. A conventional control may unnecessarily accelerate the reactions in the fuel cell leading to thermal consequences and system inefficiency. The system shown in FIG. 1 is needed most when the magnitude of the load transients is not negligible compared to the capacity of the source.

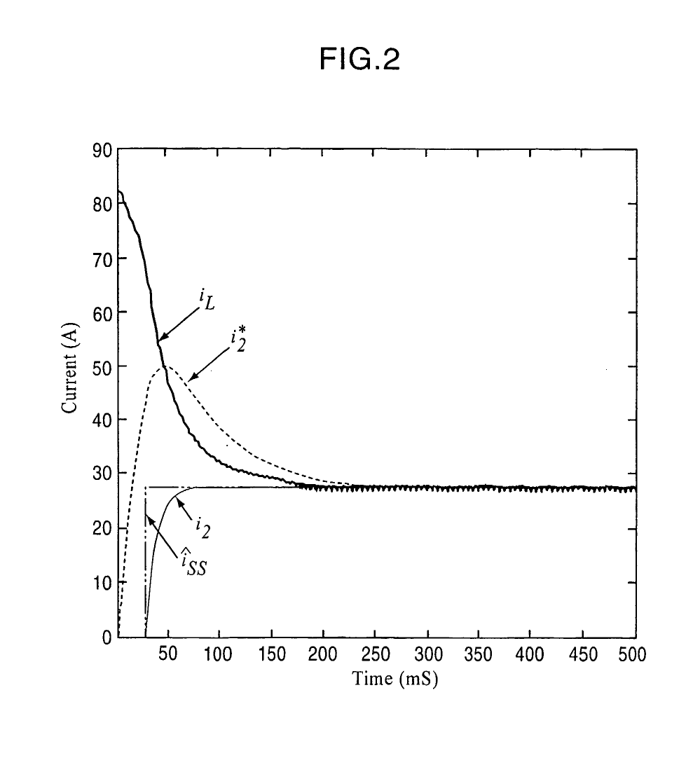

FIG. 2 shows the potential advantages of the transient control scheme in FIG. 1. The load transient, in this case an incandescent light bulb, has initial values that are large relative to the steady state value. The “conventional control” response shows how hybrid system with a linear controller might control the fuel cell for this transient. Storage sources provide the difference between the load current and the fuel cell current at the beginning of the transient. However, the fuel cell response overshoots the demand before reaching steady state. The problem with the conventional response in FIG. 2 is not the overshoot, which could probably be corrected, but the vigorous acceleration of the generating process in the fuel cell. In contrast, the transient recognition control response in FIG. 2 shows how the fuel

cell could respond to the transient given the estimate of the long-term transient behavior \tilde{l}ₛₛ. Given a class of transients, a conventional control could be designed to minimize the overshoot, fuel cell thermal excursions, or any other criterion of interest. However, that conventional control would be a compromise solution. A control that recognizes the “fingerprint” of an incoming load can provide a response that is optimal for that load.

The difficult part of the transient recognition control scheme is to ensure that the delay in estimating a useful \tilde{l}ₛₛ is as short as possible. We address this problem by adapting a recursive modification of cluster-weighted modeling to the hybrid control problem. More details of recursive cluster weighted modeling appear in [19].

### Recursive Load Transient Recognition

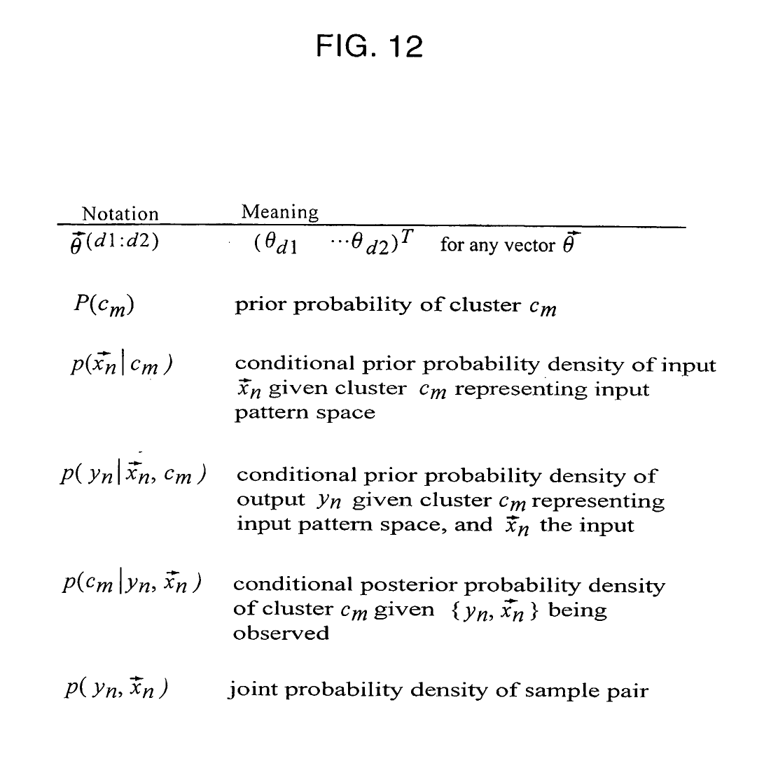

In this section, the CWM algorithm is first briefly reviewed based on the presentation and notation in [17] where the complete derivations can be found. Then, the implementation of RLTR by CWM is detailed, including a recursive modification to the conventional CWM prediction procedure to improve the real time performance of RLTR, a transient data scaling scheme to improve data storing effectiveness, and transient pattern design issue under CWM scheme. A list of explanations for the notations used in this section is summarized in FIG. 12.

### A. Cluster-Weighted Modeling

Cluster-Weighted Modeling (CWM) [16], [17], [18] is an iterative scheme of finding the probability density distributions and building up a functional mapping over a sample set {yₙ,xₙ}N, n=1, where N is the total number of samples. CWM is useful for pattern recognition, and is appealing for stochastic time series analysis and synthesis [18], [20], [21], and non-linear modeling [22]. A cluster in the CWM scheme is described by three priors, {P(cₘ),p(xₙ|cₘ),p(yₙ|xₙ, cₘ)}. P(cₘ) is the weight of cluster cₘ, reflecting the relative importance of one cluster on the overall modeling problem. p(xₙ|cₘ) is the local influence of one cluster on the input pattern. p(yₙ|xₙ, cₘ) reflects the local statistical relationship between the output and the input on one cluster. In the context of load transient recognition problem, xₙ can be configured as a load transient pattern, and yₙ is the load steady state value associated with that transient. cₘ represents one cluster for load transient modeling. One class of load transients which are similar up to a scale factor in magnitude can be modeled by one or more clusters.

The density distribution models for the priors are assumed to be Gaussian, i.e.,

$$\begin{matrix}p ( {\vec{x}}_{n} \vert {c}_{m} ) = {\prod }_{d = 1}^{D} \frac{1}{\sqrt{2 π {σ}_{m , d}^{2}}} exp [ \frac{- {( {x}_{n , d} - {μ}_{m , d} )}^{2}}{2 {σ}_{m , d}^{2}} ] , & ( 1 ) \\ p ( {y}_{n} \vert {\vec{x}}_{n} , {c}_{m} ) = \frac{1}{\sqrt{2 π {σ}_{m , y}^{2}}} exp [ \frac{- {( {y}_{n} - f ( {\vec{x}}_{n} , {\vec{β}}_{m} ) )}^{2}}{2 {σ}_{m , y}^{2}} ] . & ( 2 )\end{matrix}$$

wherein D is the dimension of transient pattern xₙ. There is not a requirement that the actual forms of p(xₙ|cₘ) and p(yₙ|xₙ, cₘ) are Gaussian. Equations (1) and (2) can be generic basis functions in a generalized version of CWM. However, the Gaussian has an intuitive probabilistic interpretation and good localization properties. Arbitrary distributions can be approximated by overlapping a set of Gaussian equations.

In (1), the covariance matrix [covᵢⱼ]_{D×D} is approximated by the diagonal variance matrix [σ²_{m,d}]_{D×D}. Although using the full covariance matrix would let the CWM be more flexible, it is not preferred if the pattern dimension is large. For a covariance matrix, the storage requirement and computational cost in matrix inversion grows quadratically with matrix dimension, while for a diagonal matrix, cost is linearly related to dimension. Furthermore, it is easier to prevent singular matrix inversion problems in the variance matrix than in the covariance matrix.

In (2), an “expectation function” ƒ(xₙ, βₘ) is used in the Gaussian distribution, instead of a constant expectation value. Accordingly, a local model ƒ(xₙ, βₘ) with parameter vector βₘ is defined for each cluster that reflects the local functional relationship between the input patterns and the output observations. βₘ is naturally determined as a part of the estimate of p(yₙ|xₙ, cₘ). The global mapping is a “cluster weighted” combination of the local mappings for each cluster. This is apparent in output prediction step,

$$\begin{matrix}〈 \hat{y} \vert {\vec{x}}_{n} 〉 = \int y \cdot p ( y \vert {\vec{x}}_{n} ) d y \\ = \frac{{\sum }_{m = 1}^{M} f ( {\vec{x}}_{n} , {\vec{β}}_{m} ) p ( {\vec{x}}_{n} \vert {c}_{m} ) P ( {c}_{m} )}{{\sum }_{m = 1}^{M} p ( {\vec{x}}_{n} \vert {c}_{m} ) P ( {c}_{m} )} .\end{matrix} \qquad ( 3 )$$

In (3) M is the total number of clusters, p(xₙ|cₘ) is the likelihood of xₙ to cluster cₘ, and the term (xₙ|cₘ)P(cₘ) is a measure of importance that one local model has on a given input. For example, a local model formulated for the cluster of bulb transients will probably have little influence on an input pattern of lathe transient because p(cₗₐₜₕₑ|c_{bulb}) is small. The denominator in (3) is a normalization factor for the weighted combination. Suggested by (3), it is apparent that (2) not only is a basis function, but also provides a mechanism for recovering the functional relationship between the input patterns and the output observations. The local model could be assumed to be as simple as the linear type,

$$f ( {\vec{x}}_{n} , {\vec{β}}_{m} ) = {\vec{β}}_{m}^{T} \cdot {\vec{x}}_{n} = {\sum }_{d = 1}^{D} {β}_{m , d} \cdot {x}_{n , d} , \qquad ( 4 )$$

if enough number of clusters are defined, so that the linear model has sufficient local accuracy. However, note that the global mapping expressed by (3) is highly non-linear with respect to the input. CWM has valuable modeling capability suggested by its non-linear essential.

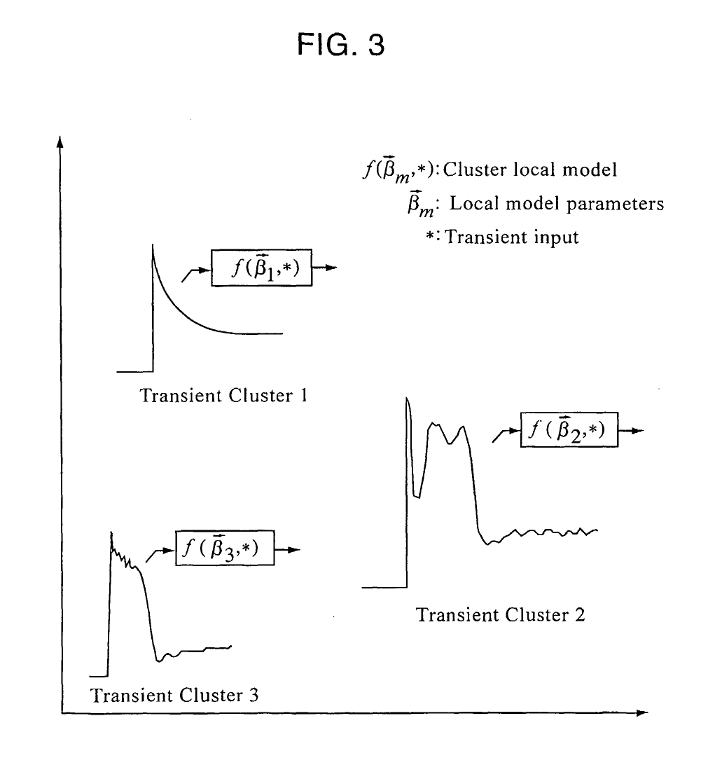

In the load transient recognition problem, the CWM can be interpreted as that of a set of filters f(*,βₘ) used for transient processing. Each filter is specially designed to give the perfect filtering for one class of transient signals. During the recognition process, which filter will be chosen is determined by the likelihood of the input transient to the transient class associated with this filter. The CWM scheme matches perfectly to the filter bank idea mentioned in the section entitled Novel Power Control Scheme for Hybrid Fuel Cell Systems for building up TRC. FIG. 3 provides a graphical explanation of the filter bank essential of a CWM scheme. The two dimensional Cartesian coordinate is used in FIG. 1 to represent the D (D>>>2 in general) dimensional vector space for transient patterns.

There are two coexisting processes in the CWM scheme. The prediction process uses equation (3) to give the CWM output. The training process is performed to find the parameters of the priors. In a given iteration of training, the posterior p(yₙ|xₙ, cₘ) is evaluated based on the priors {P(Cm), p(xₙ|cₘ), p(yₙ|xₙ, cₘ)} estimated at the last step. The priors are then updated using the new posterior information. The estimates of the priors maximize the joint log likelihood Σ^{N}ₙ₌₁ log [p(yₙ,xₙ)]. Reference [17] provides a detailed presentation of the CWM training process.

### B. Recursive Formulation of CWM Prediction

Equation (3) is the foundation of implementing the TRC for load transient steady state demand estimation, where <y|xₙ> equals iₛₛ in a hybrid fuel cell system shown in FIG. 1. However, applying equation (3) introduces a significant delay for a TRC giving valid estimates. Like most conventional pattern recognition techniques, the conventional CWM predicting depends on receiving a complete data set to classify a pattern. To improve the real time performance of the TRC, a recursive modification to equation (3) is derived in reference [19] by assuming the linear local model as defined in equation (4), i.e.,

$$\begin{matrix}〈 \hat{y} \vert {\vec{x}}_{n}^{( 1 : K )} 〉 = \frac{{\sum }_{m = 1}^{M} {\vec{β}}_{m}^{{( 1 : K )}^{T}} {\vec{x}}_{n}^{( 1 : K )} p ( {\vec{x}}_{n}^{( 1 : K )} \vert {c}_{m} ) P ( {c}_{m} )}{{\sum }_{m = 1}^{M} p ( {\vec{x}}_{n}^{( 1 : K )} \vert {c}_{m} ) P ( {c}_{m} )} + \frac{{\sum }_{m = 1}^{M} {\vec{β}}_{m}^{{( K + 1 : D )}^{T}} {\vec{μ}}_{m}^{( K + 1 : D )} p ( {\vec{x}}_{n}^{( 1 : K )} \vert {c}_{m} ) P ( {c}_{m} )}{{\sum }_{m = 1}^{M} p ( {\vec{x}}_{n}^{( 1 : K )} \vert {c}_{m} ) P ( {c}_{m} )} , & ( 5 ) \\ = \frac{{\sum }_{m = 1}^{M} \{ ( {\vec{x}}_{n}^{{( 1 : K )}^{T}} {\vec{μ}}_{m}^{{( K + 1 : D )}^{T}} ) \cdot {\vec{β}}_{m}^{( 1 : D )} \} p ( {\vec{x}}_{n}^{( 1 : K )} \vert {c}_{m} ) P ( {c}_{m} )}{{\sum }_{m = 1}^{M} p ( {\vec{x}}_{n}^{( 1 : K )} \vert {c}_{m} ) P ( {c}_{m} )} . & ( 6 )\end{matrix}$$

where xₙ^{(1:K)} is the partial transient received by the step K, and p(xₙ^{(1:K)}|cₘ) is the partial likelihood evaluated at step K(K≦D). The first item at the right hand side of equation (5) has a form similar to equation (3). This item is the conventional CWM prediction at step K, based on the available transient information xₙ^{(1:K)}. The second item in the right hand side of equation (5) is the cluster weighted correction to the model prediction at step K, based on available prior information μₘ^{(K+1:D)} learned through the training process. Equation (5) is rewritten in equation (6). The vector [x^{(1+K)T}μₘ^{(K+1:D)T}]^{T} is a recovery of complete vector xₙ^{(1:D)} at step K by cluster cₘ, where μₘ^{(K+1:D)} is the most likely prediction by each cluster of the un-received part of the transient. This recursive recognition is summarized as: Recover the complete transient data xₙ^{(1:D)} by producing the un-received part xₙ^{(K+1:D)} with available prior information by each cluster, then use the recovered complete transient vector and the partial likelihood p(xₙ(1:K)|cₘ) evaluated at the current step to compute the CWM model prediction as defined in equation (6).

### C. Transient Data Scaling

Transient data scaling is an important issue for TCR implementation. A good scaling strategy will reduce the amount of the information needed to be stored. It is generally not necessary to record the transients of all possible loads in a target system because different loads in the same class normally have transients that are similar up to a scale factor in magnitude. Similar transients can be matched to one normalized transient exemplar. For example, NILM determines the scale factor between the transient and the exemplar as part of the event classifying problem. See [14]. One way of scaling transients is to normalize the data by the associated steady state values. After normalization, the transients will have a steady state load current of one. The load transients in the same class would be expected to merge into one cluster. In the training process, the normalized transient samples are used to find the maximum likelihood prior parameters for the CWM model. In the following, we mark the prior parameters with superscript “tilde” to note that they are obtained through the training with the normalized samples, for example, μₘ, σ²_{m,i}.

In the production process, because the steady state information of the income transients is not available until the transient periods finish, a suitable scale factor should be determined recursively by the following two-step procedure instead.

Step 1: At step K, determine a maximum likelihood scale factor aₘ^{ML} between the transient data xₙ^{(1:K)} received and each cluster cₘ by solving the constrained optimal problem as

maxₐ_{ₘ}[log p({right arrow over (\tilde{x}ₙ^{(1:K)}|cₘ,aₘ)], (7)

subject to: aₘε(aₘ^{min} aₘ^{max}),

where K=1, 2, . . . , D; m=1, 2, . . . , M, and

{right arrow over (\tilde{x}ₙ^{(1:K)}=aₘ·(\vec{x}ₙ^{(1:K)}−b), (8)

is a scaled estimate of xₙ^{(1:K)} for cluster cₘ, and b is the offset which equals the steady state value on the load bus before the transient occurs. The limits aₘ^{min} and aₘ^{max} determine the reasonable scaling range for the transients in cluster cₘ. A detailed derivation is contained in reference [19].
Step 2: Compare the likelihoods p(xₙ^{(1:K)}|cₘ, aₘ^{ML}) for different clusters to find which cluster has the maximum likelihood and use the corresponding scale factor for xₙ^{(1:K)}, i.e.,

a^{ML}=a_{M}^{ML}, (9)

M=arg{aₘ^{ML}:maxₘ[p({right arrow over (\tilde{x}ₙ^{(1:K)}|cₘ,aₘ^{ML})]}. (10)

The same result for aₘ^{ML} can be derived by solving the following weighted least squares problem,

$$\begin{matrix}{J}_{m}^{K} = {\vec{e}}_{m}^{{( 1 : K )}^{T}} \cdot {W}_{m}^{( 1 : K )} \cdot {\vec{e}}_{m}^{( 1 : K )} , & ( 11 ) \\ {\vec{e}}_{m}^{( 1 : K )} = {\tilde{\vec{μ}}}_{m}^{( 1 : K )} - {a}_{m} \cdot ( {\vec{x}}_{n}^{( 1 : K )} - b ) , & ( 12 ) \\ {W}_{m}^{( 1 : K )} = ( \begin{matrix}1 / {\tilde{σ}}_{m , 1}^{2} & … & 0 \\ ⋮ & ⋱ & ⋮ \\ 0 & … & 1 / {\tilde{σ}}_{m , K}^{2}\end{matrix} ) , & ( 13 )\end{matrix}$$

As suggested by equation (11), the best scaling factor is determined not only by minimizing the Euclidian distance between the cluster centers and the scaled transient data, but also by considering the scale ranges of the clusters.

The offset b can be evaluated by a sliding window average. This offset reflects the steady state status on the load bus and can replace the iₛₛ in FIG. 1 during the steady state periods to prevent any possible estimation error from being accumulated.

### D. Transient Exemplar Design

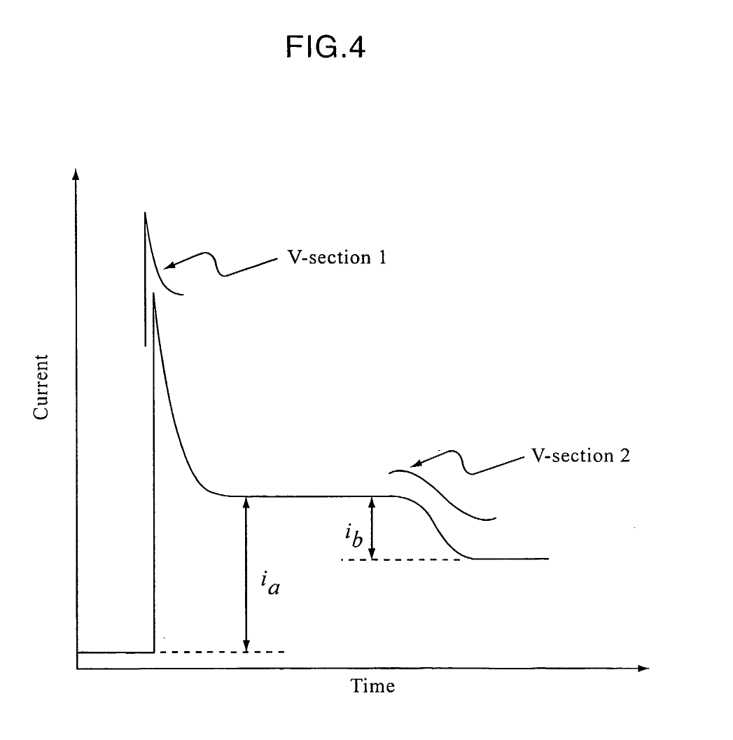

Load transients can be characterized by narrow segments with relatively high derivative or mean value variation information, called v-sections (see e.g., FIG. 4). A load transient can have one or more v-sections. Each v-section represents a significant variation in the steady state power dissipation, and can be modeled individually by CWM.

Using v-sections instead of the entire transient to do the load transient recognition problem is preferred because the v-sections are less likely to overlap in a transient stream than an entire transient. See e.g., [15]. NILM incorporates two steps in recognizing the load transient. See e.g., [23]. The first step is to match the stored v-sections to the incoming data, and the second step is to “connect” the matched v-sections to interpret potential load transient events.

It is difficult to “connect” v-sections in real time in order to match with the real time operation of RLTR. However, a tradeoff can be made. The individual v-section can be viewed as an independent transient exemplar because it is only necessary to predict the steady state value change following each v-section. For example, in FIG. 4, the first v-section implies a step increase of Iₐ in steady state and the second v-section implies a step decrease of I_{b} in steady state. Precisely identifying the type of load is not necessary.

Another important issue in transient exemplar design is to determine the length of the v-sections. Because of the errors from scaling and measurement, clusters for short v-sections could match well to the former part of some long v-sections. To prevent the false matching between the short and long v-sections, short v-sections can be extended with a segment of dummy steady state data. On the other hand, in order to save computational cost and storage space, long v-sections can be truncated by some extent, because from experience it is not necessary to investigate the complete data set of a long v-section in making good recognition. There are tradeoffs between how many points are patched to the short v-sections and how many points are truncated from long v-sections. The longer the exemplar v-section designed, the more accurate the final recognition result. On the other side, the shorter the v-section designed, the less probability of overlapping occurs during recognition process, and the less computational cost and storage space required.

### TRC Operation Flowchart

Based upon the work for TRC implementation, an operation flowchart of the TRC is outlined below:

Step 1: Doing pre-processing for the input transient signal x^{(1:K)} to eliminate noise;
Step 2: Determine the maximum likelihood scale factor a^{ML} by the two-step procedure described in the Transient Data Scaling section, and compute the instant scaled transient data as

x^{(1:K)}=a^{MLx}(x^{(1:K)}−b); (14)

Step 3: Compute the partial likelihood p(x^{(1:K)}|cₘ, a^{ML}) for each cluster;
Step 4: Recover the scaled complete transient vector by maximum likelihood prediction for each cluster,

x^{(1:K)}=[x^{(1:K)}μₘ^{(K+1:D)T}]T (15)

Step 5: Calculate <\tilde{y}|x^{(1:K)}> according to equation (6);
Step 6: Recover the un-scaled output,

<\tilde{y}|x^{(1:K)}>=1/a^{ML}·<\tilde{y}|x^{(1:K)}>+b (16)

### EXAMPLES

The invention is further defined by reference to the following examples. The examples are representative, and should not be construed to limit the scope of the invention.

In the examples, the effectiveness of the TRC was first verified using the true load transient data for training and testing. The hybrid fuel cell system was then built up in hardware for verifying the power control scheme illustrated in section II.

### Example I

### Experiments on TRC

Several types of true load transient data were gathered from DC/AC inverter and AC loads systems. The recorded data stream was first processed for eliminating the coupled noise from the instruments. Then informative v-sections of load transients were extracted, sorted to different transient classes, and synchronized to each other within the same class. Each class of transients is split into two parts, the training subset and the testing subset. The transients in training sub-set were first shifted so that the starting offset was approximately zero. The data was then normalized by the corresponding steady state values. The instrumentation for transient setup comprises a DC power source, a DC/AC inverter, a voltage/current sensor board installed on the DC side of the inverter, a USB real time data gathering card, and a host computer for data recording. The specifications of the instruments are summarized in Table II. Data was collected at a sampling rate of 1 kHz for the purpose of limiting the amount of the data needs to be processed. DC bus voltage was fixed to 12 volts. Five types of transients were chosen, including a lathe, bulb, computer monitor, drill, and vacuum cleaner. The monitor transient includes 2 separate v-sections which were treated as two individual transients. A total of 265 transients were recorded. The numbers of the recorded transients for the training and testing subsets in different transient classes are summarized in Table III.

In our implementation, it was necessary to filter transient data before use due to the inverter switching noise being coupled into the transient signals. The switching noise was highly harmonic, about 120 Hz, and can be effectively filtered using a low-pass filter with reasonable length. In the experiment, a moving average filter was used with the first notch of it being intently set to 120 Hz. The delay introduced by the moving average filter can be less than other kinds of advanced low-pass filters. In the experiment, the delay was not significant compared to the length of the transients gathered. For example, the length of the transients collected is about 250 to 2500 sample points given a 1 kHz sampling rate, and the filter length was 17. It may be desirable to use a passive power-level filter to attenuate switching noise.

TABLE II

| Instrument | Specifications |
|---|---|
| DC power source | HP 6011 DC power supply, |
| | 0-20 V/0-120 A, 1000 W |
| DC/AC inverter | Prowatt 1750 (XANTREX) |
| | Input: 12-15 V dc I 0-200 A |
| | Output: 115 Vac 160 Hz |
| Sensor board | LEM LA100-P hall effect active |
| | current sensor, 120 A max |
| Custom USB data gathering card | AD7856AN0229 AID converter, |
| | 14 bits |
| Host computer | AMD 850 MHz, Redhat Linux 8.0 |

TABLE III

| Transient | Training | Testing |
|---|---|---|
| Lathe | 40 | 8 |
| Monitor v-section 1 | 30 | 6 |
| Monitor v-section 1 | 30 | 6 |
| Bulb | 51 | 17 |
| Drill | 30 | 10 |
| Vacuum | 28 | 9 |
| Total | 209 | 56 |

### CWM Model Training

The training was performed for finding a suitable set of cluster parameters, such as cluster mean vectors, variances, and local model parameters. More than one cluster may be used to model a class of transients if the class is highly variable. Cluster probability P(cₘ) is initialized as 1/M. Local model's parameter βₘ is initialized with a small random number. The initial positions of clusters should not be initialized randomly, because this will cause an unreasonably long time for the clusters to converge to the expected positions. See e.g., [18]. Therefore random initialization may not guarantee the clusters to converge perfectly according to the variations of each transient class. A practical way of initializing the cluster centers is to predefine the number of clusters needed for each transient class modeling. This is mainly determined by the variability of the transient class. Then the set of clusters used to model one class are initialized to the mean position of that class, plus small random perturbations. This implies that the transients in one class initially have equal likelihoods, because no prior information is available before training. Adding small random perturbations to the initial cluster centers effectively dispatches clusters to span the transient variability. Variances of p(xₙ|cₘ) and P(yₙ|xₙ, cₘ) are initialized to be a constant 100. During training, it is also necessary to add small constants to the variances, preventing them from shrinking to zero. See e.g., [17].

Before training, the gathered transients were downsampled by 10 to further save the computational cost. The transient length was set to D=50 after down-sampling. 27 clusters were used to model six classes of transients. (Monitor transients have two v-sections.) The allocation of clusters for different transient classes is summarized in Table IV. 5000 iterations were performed for training.

After training, the cluster probability P(cₘ) was checked to ensure that no clusters had infinitesimal probability. In this was the case, the number of clusters and the clusters allocation for transient classes were adjusted, and the training was re-performed. The converged clusters' positions were also checked relative to the position for each transient class. If any cluster converged far from the transients, the raining was also re-performed. The criterion for training is to maximize the joint log-likelihood.

V(h)=Σ^{N}ₙ₌₁ log p(yₙ,xₙ)

h=1, 2, . . . , 5000, is iteration number.

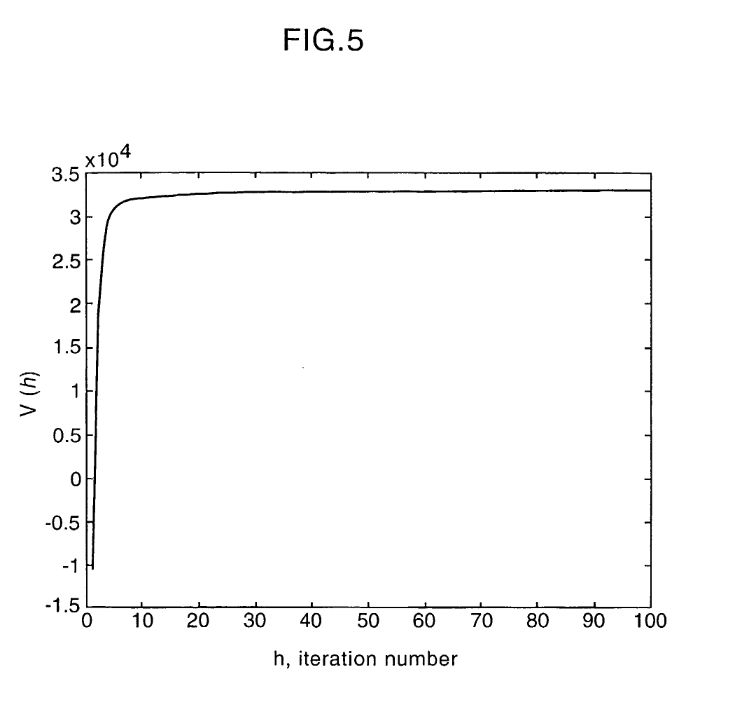

The convergence curve of V(h) is shown in FIG. 5, suggesting that CWM converged fast. N in FIG. 5 is the number of transients for training. In this example, 50-100 iterations, instead of 5000, are sufficient.

TABLE IV

| Transient Class | Number of Clusters |
|---|---|
| Lathe | 6 |
| Monitor v-section 1 | 6 |
| Monitor v-section 2 | 6 |
| Bulb | 3 |
| Drill | 3 |
| Vacuum | 3 |

TABLE V

| Component | Instrumentation |
|---|---|
| Fuel cell | SR-12 Modular PEM Generator |
| | Avista Labs |
| DC/DC converter | KXA-80-10-20 |
| | AUX PWM servo Amplifier |
| | Kollmorgen Motion Tech. |
| Battery | LC-RD1217P Lead-Acid, 12 V |
| DC/AC inverter | XP600 Power Inverter |
| | EXELTECH |
| | 20-40 V wide range DC input |
| | 117 V/60 Hz AC output |
| | 600 W rated power |
| | 1100 W surgery |
| Solid state replay | 3-32 V input(control) |
| | 24-280 V AC output |
| Arbitrary wave generator | Tektronix AFG320 |

### Testing Results

A separate set of transient data, not issued for training, was used for testing. The testing procedure is essentially the same as the procedure for TRC working in real time applications, which is outlined in the TRC Operation Flowchart.

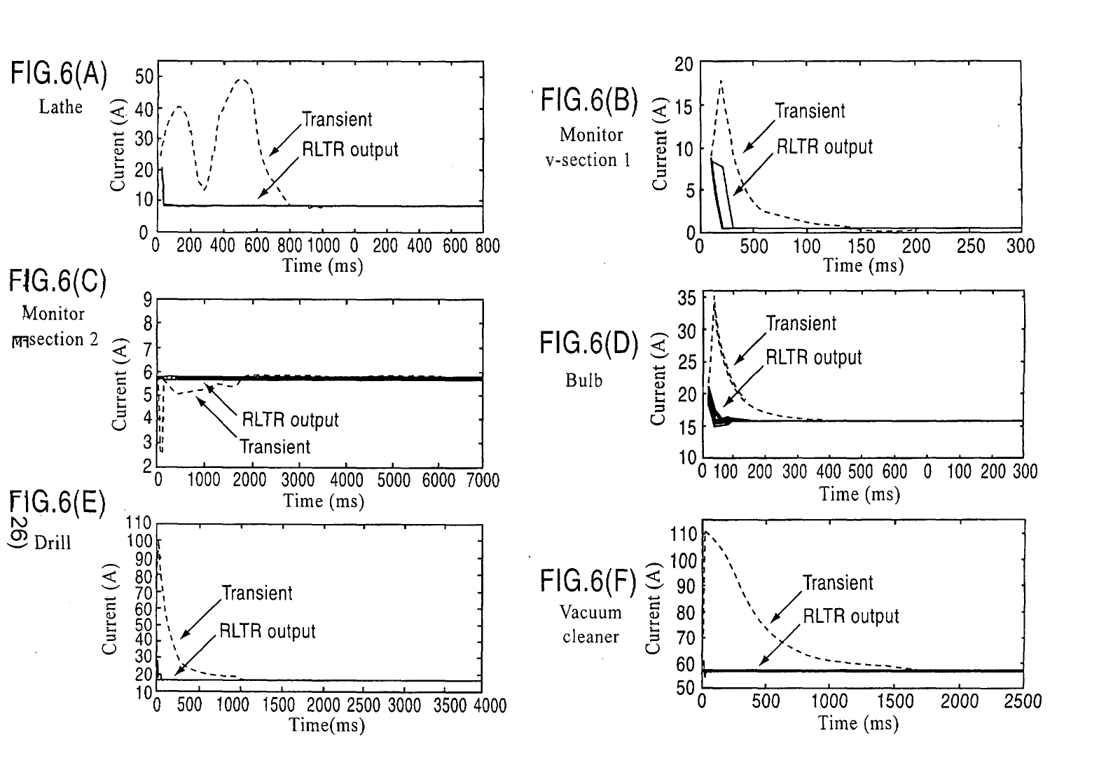

Recursive recognition results are shown in FIG. 6 for all of the 56 testing transients and corresponding TRC outputs. The dashed lines are transients and the solid lines are TRC online outputs. The TRC outputs have prediction errors (spikes) at the beginning of the recursive recognition process. However, the output converges to the correct value very quickly, as compared to the length of the transients. In field applications, a “lock-out” interval would prevent spurious TRC outputs from being coupled into the fuel cell control system. In this experiment, the delay is about 30 to 50 mS given the transient length of 250 to 2500 mS. One way to reduce the magnitude of the prediction errors is to further constrain the scaling range (aₘ^{min}, and aₘ^{max}) for each cluster. The typical scale factor of one cluster, noted as a aₘ^{typical}, is the mean steady state value of the transients of one class to which that the cluster is allocated. The aₘ^{min} and aₘ^{max} are then determined by

aₘ^{typical}/aₘ^{min}≦R,aₘ^{max}/aₘ^{typical}≦R

where R=4 for this experiment. aₘ^{typical} for a cluster is determined interactively after training.

### Example II

### Experiments on Hybrid Fuel Cell Hardware System

Two fuel cell hardware systems were built up and tested in the experiments. One is the hybrid fuel cell system with the proposed novel power control scheme illustrated in section II, making use of the transient steady state information supplied by TRC. The other is a simple fuel cell power supply system without using the transient recognition information and fast sources. The purpose of the simple fuel cell system is to show a “worst” case of the load of transient response by fuel cell, and using it as a reference for measuring the quality improvement of the load transient response of the hybrid fuel cell system.

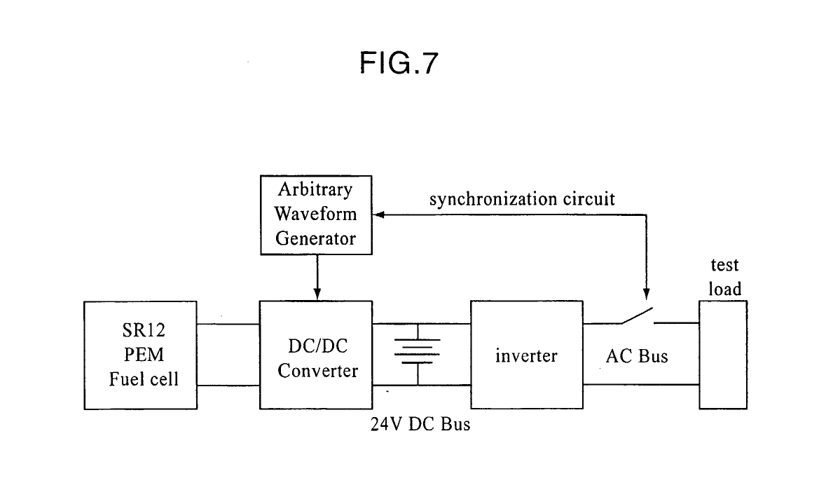

The composition of the two fuel cell power systems are illustrated in the black diagrams in FIG. 7 and the components of the instrumentation are listed in Table V. In the implementation of the hybrid fuel cell system with TRC based power control, because the TRC had not been implemented in real time sense (DSP or FPGA), an arbitrary wave generator (AWG) was used to approximate its function in the hybrid fuel cell system. The AWG was set in the triggering mode, i.e., the AWG output is turned on by external trigger signal. The turning on time of the AWG wave output and the load was synchronized by the synchronizing circuit shown in FIG. 7, and the turning on phase of the load was controlled by the 60 Hz clock extracted from the inverter AC side voltage output. The output of AWG is a delay programmable step wave, functioning as the current control command to the DC/DC converter. The delay of AWG output is an approximation to the “lock-out” interval of the TRC output. The DC/DC converter is a DC motor driver set in current control mode. The DC/DC converter is designed to drive inductance kind load (the motor). However, in the hybrid fuel cell system, it was used to drive the capacitance kind load (the battery and the inverter). This could cause the quality of the output current to be worse than the case in the driver motor, and there could be oscillation in the converter output current. An inductor is added at the input side of the converter to prevent the oscillation from being coupled into the fuel cell output current. The DC/AC inverter is modified to tolerate a wide range of input voltage variation between 20 to 40 V. Therefore, in the implementation of the simple fuel cell power supply system, the fuel cell can be directly connected to the DC/AC inverter to supply a wide range of power level.

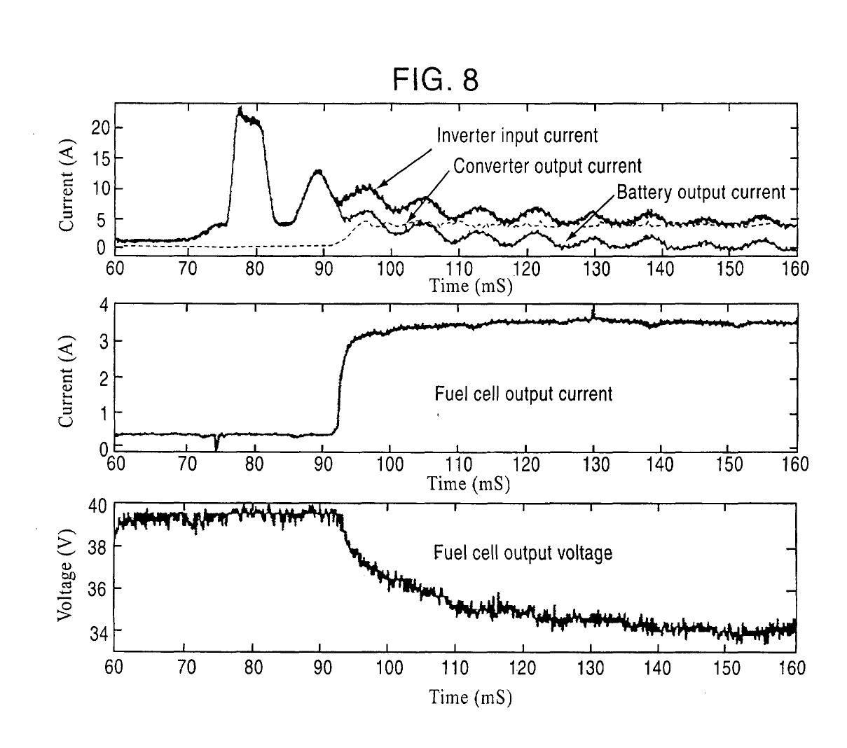

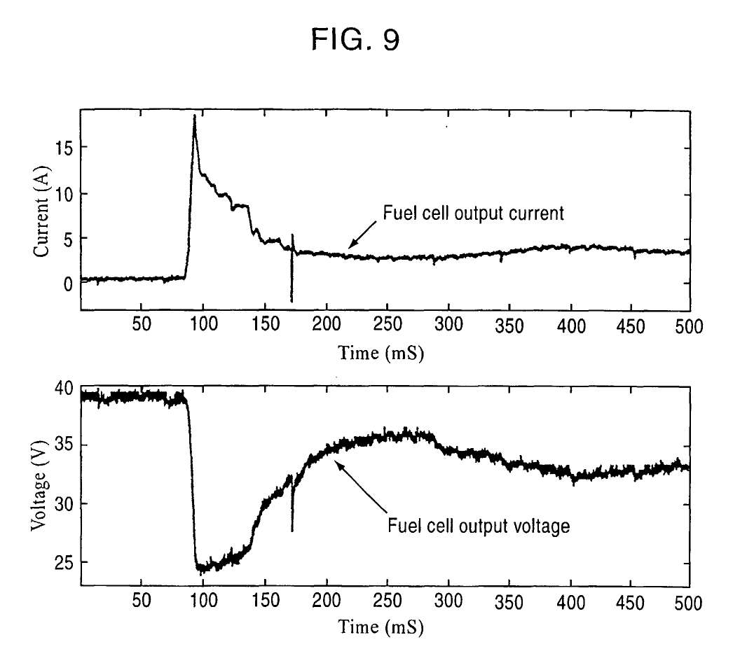

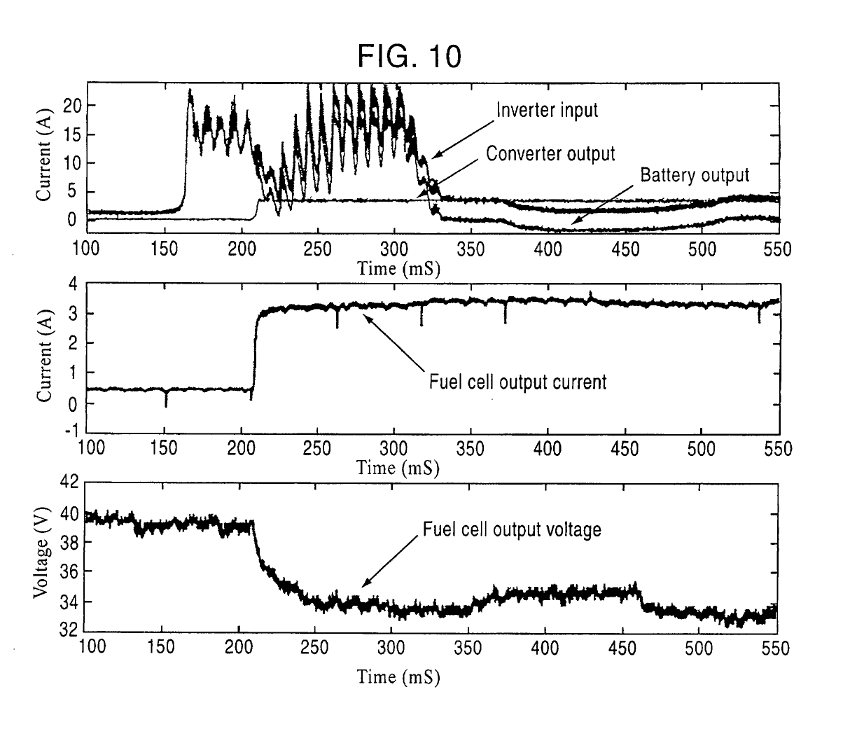

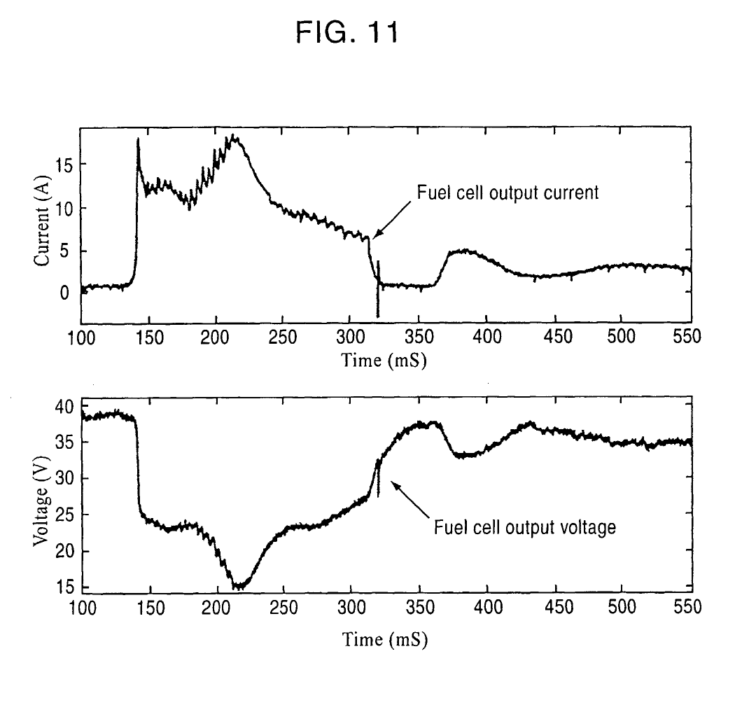

Two load transients were used in experiments for testing the current responses of the fuel cell systems: one is a bulb transient, the other is a lathe transient. FIGS. 8-11 show the tested voltage and current responses of the two fuel cell systems to the two load transients respectively. The signals were measured with a Tektronix TDS3054B oscilloscope. The probe sampling bandwidth was set to 20 MHz, and the discrete sampling rate of the oscilloscope was set to 10 KHz. The oscillation of the converter output current was caused by the interaction between the capacitance load (battery and inverter) and the converter which was designed to work well with inductance load (motor). The coupled oscillation on the converter input side was effectively isolated from the fuel cell and the converter. The low frequency ripple (about 70 Hz) within the fuel cell output current in the hybrid fuel cell system was due to the membrane switching feature of the PEM fuel cell. The transient shapes measured in the hybrid fuel cell system experiment were deformed a little bit from the transients used for training the testing the TRC in the previous experiment. This is because the dynamics of the inverter used in the previous experiment is quite different from the inverter used for hybrid fuel cell systems.

Through the comparison of the load transient responses of the two fuel cell systems, the quality of the load transient response of the hybrid fuel cell system is apparently improved by applying the TRC based power control scheme. In the hybrid fuel cells system, the possible overshoot caused by the load transient requirement was prevented from the fuel cell output current response. However, in the simple fuel cell system, the output current of the fuel cell passively followed the load transient requirements, and the overshoots in the fuel cell transient response were still significant, although the transient had been smoothed by some extension of the fuel cell slow dynamics. It must be noted that only adjusting the dynamic of converter and inverter, instead of making use of the predicted load transient steady state information, can not help eliminate all possible load transient shock on fuel cell output.

The experimental results on TRC testing suggest that it is not necessary to use the physical length of a transient as a complete pattern. An effective fraction of a transient pattern can be determined empirically. For example, the effective length of a pattern in FIG. 6 can be 5 to 10 (given 100 Hz sampling rate), far smaller than the length of 50 as originally determined before training. The model output converges well by 10 steps and almost no new information is contributed after 5 steps. Using the effective length of the transient could save computational cost and storage space, helping solve numerical problems, and improve real time performance. These factors are especially important for TRC implementation in hardware. On the other hand, reducing the pattern length may also reduce the robustness. We expect to see shorter patterns as well as robustness.

Various modifications of the invention in addition to those shown and described herein will be apparent to those skilled in the art from the foregoing description. Such modifications are also intended to fall within the scope of the appended claims. The foregoing disclosure includes all the information deemed essential to enable those skilled in the art to practice the claimed invention.

A number of references have been cited, the entire disclosure of which are incorporated by reference.

### REFERENCES

[1] L. P. Jarvis, T. B. Atwater, and P. J. Cygan, “Fuel cell/electrochemical capacitor hybrid for intermittent high power applications,” Journal of Power Sources, vol. 79, pp. 60-63, 1999.
[2] K. W. Park, H. J. Ahn, and Y. E. Sung, “All-solid-state supercapacitor using a nafion polymer membrane and its hybridization with a direct methanol fuel cell,” Journal of Power Sources, vol. 109, pp. 500-506, 2002.
[3] J. C. Amphlett, E. H. de Oliveira, R. F. Mann, P. R. Roberge, A. Rodrigues, and J. P. Salvador, “Dynamic interaction of a proton exchange membrane fuel cell and a lead-acid battery,” Journal of power Sources, vol. 65, pp. 173-178, 1997.
[4] P. B. Jones, J. B. Lakeman, G. O. Mepsted, and J. M. Moore, “A hybrid power source for pulse power applications,” Journal of power Sources, vol. 80, pp. 242-247, 1999.
[5] J R. Nojima, I. Takano, and Y. Sawada, “Transient performance of a new-type hybrid electric power distribution system with fuel cell and smes,” pp. 1303-1308, IECON'OL, the 27th Annual Conference of the IEEE Industrial Electronics Society, 2001.
[6] L. P. Jarvis, P. J. Cygan, and M. P. Roberts, “Hybrid power source for manportable applications,” IEEE Aerospace and Electronic Systems Magazine, vol. 18, pp. 13-16, January 2003.
[7] L. P. Jarvis, T. B. Atwater, E. J. Plichta, and P. J. Cygan, “Power assisted fuel cell,” Journal of Power Sources, vol. 70, pp. 253-257, 1998.
[8] L. P. Jarvis, T. B. Atwater, and P. J. Cygan, “Hybrid power sources for land warrior scenario,” IEEE Aerospace and Electronic Systems Magazine, vol. 15, pp. 37-41, September 2000.
[9] L. U. Gokdere, K. Benlyazid, R. A. Dougal, E. Santi, and C. W. Brice, “A virtual prototype for a hybrid electric vehicle,” Mechatronics, vol. 12, pp. 575-593, 2002.
[10] H. S. Lee, K. S. Jeong, and B. S. Oh, “An experimental study of controlling strategies and drive forces for hydrogen fuel cell hybrid vehicles,” International Journal of Hydrogen Energy, vol. 28, pp. 215-222, 2003.
[11] K. S. Jeong and B. S. Oh, “Fuel economy and life-cycle cost analysis of a fuel cell hybrid vehicle,” Journal of Power Sources, vol. 105, pp. 58-65, 2002.
[12] L. Bertoni, H. Gualous, D. Bouquain, D. Hissel, M. C. Pera, and J. M. Kauffmann, “Hybrid auxiliary power unit (apu) for automotive applications,” pp. 1840-1845, Vehicular Technology Conference 2002. Proceedings. VTC 2002-Fall, 2002 IEEE 56th, September 2002.
[13] M. Nadal and F. Barbir, “Development of a hybrid fuel cell/battery powered electric vehicle,” International Journal of Hydrogen Energy, vol. 21, no. 6, pp. 497-505, 1996.
[14] S. R. Shaw, S. B. Leeb, and L. K. Norford, “Nonintrusive load monitoring and diagnostics in power systems,” submitted to IEEE transactions in 2003.
[15] S. R. Shaw, C. B. Abler, R. F. Lepard, D. Luo, S. B. Leeb, and L. K. Norford, “Instrumentation for high performance nonintrusive electrical load monitoring,” ASME Journal of Solar Energy Engineering, vol. 120, pp. 224-229, August 1998.
[16] N. Gershenfeld, B. Schoner, and E. Metois, “Cluster weighted modeling for time-series analysis,” Nature, vol. 397, pp. 329-332, January 1999.
[17] N. Gershenfeld, The Nature of Mathematical Modeling. Cambridge University Press, 1999.
[18] B. Schoner and N. Gershenfeld, “Cluster-weighted modeling: Probabilistic time series prediction, characterization and synthesis,” pp. 365-385, Alistair Mees(Ed.), Birkhaeuser, Boston, 2000.
[19] T. Zhu, S. R. Shaw, and S. B. Leeb, “Recursive pattern recognition by cluster-weighted modleing,” to be submitted to IEEE Transactions on pattern recognition, 2004.
[20] B. Schoner, C. Cooper, C. Douglas, and N. Gershenfeld, “Datadriven modeling and synthesis of acoustical instruments,” (Ann Arbor), International Computer Music Conference, October 1998.
[21] B. Schoner, C. Cooper, and N. Gershenfeld, “Cluster-weighted sampling for synthesis and cross-synthesis of violin family instruments,” (Berlin, Germany), Proc. International Computer Music Conference, August 2000.
[22] B. Schoner and N. Gershenfeld, “Data-driven modeling of nonlinear microwave devices,” (Anaheim, Calif.), Digest 53rd ARFTG Conference on Nonlinearity Characterization, June 1999.
[23] S. R. Shaw, System Identification Techniques and Modeling for Non-intrusive Load Diagnostics. Ph.D. thesis, MIT, February 2000.

1. A method for controlling a power generation system comprising using a transient recognition control module to estimate the steady state information of load transients.

2. The method of claim 1, wherein the transient recognition control module is based upon a cluster weighted modeling algorithm.

3. The method of claim 1, wherein the power generation system is a hybrid fuel cell system.

4. The method of claim 1, wherein the cluster weighted modeling algorithm is formulated recursively.

5. The method of claim 1, wherein the cluster weighted modeling algorithm provides feed-forward information in real time.

6. A method for controlling a power generation system comprising:
a) providing a power electronics source which is electrically connected to a power generation source, an energy storage device, a transient recognition control device, and a DC bus;
b) providing a current sensor that is electrically connected to a transient recognition control device;
c) estimating the steady state load transient information in the transient recognition control device using a computer weighted modeling algorithm;
d) adjusting the use of energy from the storage device and the power generation source based upon an input command signal from the transient recognition control system to the power electronics; and
d) regulating the voltage on the DC bus based upon a signal from the power electronics.

7. The method of claim 5, wherein the power generation system is a hybrid fuel cell system.
